(19) United States
(12) Patent Application Publication
(10) Pub. No.: US 2009/0297882 A1
(43) Pub. Date: Dec. 3, 2009

(54) Brazing filler metal, brazing filler metal paste, and heat exchanger

(75) Inventors: Tooru Ikeda, Kariya-city (JP); Haruhiko Watanabe, Obu-city (JP); Shin Takewaka, Kariya-city (JP); Tomoaki Akazawa, Kakogawa-city (JP); Koichi Miyake, Ageo-city (JP)

Correspondence Address: HARNESS, DICKEY & PIERCE, P.L.C., P.O. BOX 828, BLOOMFIELD HILLS, MI, 48303, US

(73) Assignees: DENSO CORPORATION, Kariya-city (JP); Harima Chemicals, Inc., Kakogawa-shi (JP)

(21) Appl. No.: 12/455,224

(22) Filed: May 29, 2009

(30) Foreign Application Priority Data
May 30, 2008 (JP) 2008-142365

(51) Int. Cl. B32B 15/20; B22F 1/00; B23K 35/34

(52) U.S. Cl. 428/675; 75/252; 148/24

(57) ABSTRACT

A brazing filler metal includes quaternary alloy powder and copper powder. The quaternary allow powder consists of from 0.1 to 27.4 mass percent tin, from 0.8 to 5.1 mass percent nickel, from 2.2 to 10.9 mass percent phosphorous and a balance including copper and any unavoidable impurity. The brazing filler metal can be used in a form of paste by being mixed with an organic binder and an organic solvent. The brazing filler metal and the brazing filler metal can be used for joining members made of copper or copper alloy, such as members of a heat exchanger.

### CROSS REFERENCE TO RELATED APPLICATION

This application is based on Japanese Patent Application No. 2008-142365 filed on May 30, 2008, the disclosure of which is incorporated herein by reference.

### FIELD OF THE INVENTION

The present invention relates to a brazing filter metal and a brazing filler metal paste used for joining members made of copper or copper alloy, and a heat exchanger joined with one of the brazing filler metal and the brazing filler metal paste.

### BACKGROUND OF THE INVENTION

Conventionally, it has been proposed to use a quaternary brazing filler metal, which contains copper, tin, nickel and phosphorous, as a brazing filler metal for joining members made of copper or copper alloy to avoid softening base materials of the members under a high temperature. Such a quaternary brazing filler metal is described in JP-B2-3081230 and U.S. Pat. No. 5,378,294, for example.

The above quaternary brazing filler metal is a eutectic alloy and has a low melting point, approximately 600 degrees Celsius, thereby to enable to carry out brazing under a low temperature. However, the above quaternary brazing filler metal is delicate and thus will not be suitable to join portions requiring strength, such as joining portions between tubes and a header plate of a heat exchanger.

### SUMMARY OF THE INVENTION

It is proposed to reduce the tin content and increase the copper content so as to increase joining strength. In such a quaternary brazing filler metal, however, because fluidity thereof is deteriorated, if it is used to join portions tilted, an eutectic portion thereof flows downwardly while a copper-rich high viscosity portion remains in an upper location of the portions to be joined. In this case, it is difficult to form a joint with uniform composition. Also, because a fillet may not be formed by the copper-rich portion, which remains in the upper location, efficiency of the brazing filler metal is likely to be reduced.

The present invention is made in view of the foregoing matter, and it is an object of the present invention to provide a brazing filler metal and a brazing filler metal paste having sufficient fluidity with a low melting point while improving the joining strength, and to provide a heat exchangers in which members are joined with a joint formed from the brazing filler metal or the brazing filler metal paste.

According to an aspect of the present invention, a brazing filler metal for joining members made of one of copper and copper alloy includes quaternary alloy powder and copper powder. The quaternary alloy powder consists of from 0.1 to 27.4 mass percent tin, from 0.8 to 5.1 mass percent nickel, from 2.2 to 10.9 mass percent phosphorous and the balance being copper and any unavoidable impurity.

Since the copper powder is mixed with the quaternary alloy powder, which has a composition ratio similar to eutectic, the brazing filler metal has fluidity and a melting point substantially equal to those of a eutectic brazing filler metal. Further, because a copper phase, which is a factor of increasing strength, increases, the joining strength improves. Furthermore, because the quaternary alloy has a melting point lower than that of copper, the copper powder can be carried by a melted quaternary alloy. Therefore, even if the brazing filler metal is used to join tilted portions, a joint can be formed with substantially uniform composition.

For example, a mixing ratio of the copper powder can be from 2 to 20 mass percent. The copper powder can have a particle diameter of 1 to 50 μm. A ratio of the tin in the quaternary alloy can be from 10 to 20 mass percent. Also, the balance may include unavoidable impurities, such as zinc, or may not include unavoidable impurities.

According to a second aspect of the present invention, a brazing filler metal paste includes the brazing filler metal, an organic binder and an organic solvent. Also in this case, the similar effects can be achieved.

According to a third aspect of the present invention, a heat exchanger includes a first member made of one of copper and copper alloy, a second member made of one of copper and copper alloy, and a joint joining the first member and the second member. The joint is formed from one of the brazing filler metal and the brazing metal paste. Accordingly, the first member and the second member are joined to one another with sufficient strength.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1A is a plan view of a heat exchanger according to an embodiment of the present invention;

FIG. 1B is an enlarged cross-sectional view of a joining portion between a tube and a header plate of the heat exchanger according to the embodiment;

FIG. 2 is a diagram showing specific examples of a brazing filler metal according to the embodiment and comparative examples of the brazing filler metal;

FIG. 3 is a diagram showing a copper phase area ratio of the specific example and the comparative examples of the brazing filler metal;

FIGS. 4A and 4B are schematic views of a testing apparatus for testing fluidity of the brazing filler metal;

FIG. 4C is a diagram showing test results of the fluidity of the specific example and the comparative examples of the brazing filler metal;

FIG. 5A is a diagram showing a primary crystal area ratio of copper and a void area ratio of the specific examples and the comparative examples of the brazing filler metal;

FIG. 5B is a graph showing a relationship between a copper powder mixing ratio and the primary crystal area ratio of copper of the specific examples and the comparative example of the brazing filler metal;

FIG. 5C is a graph showing a relationship between the copper powder mixing ratio and the void area ratio of the specific examples and the comparative examples of the brazing filler metal; and

FIG. 6 is a diagram showing the void area ratio of the specific example and the comparative examples of the brazing filler metal.

### DETAILED DESCRIPTION OF EXEMPLARY EMBODIMENT

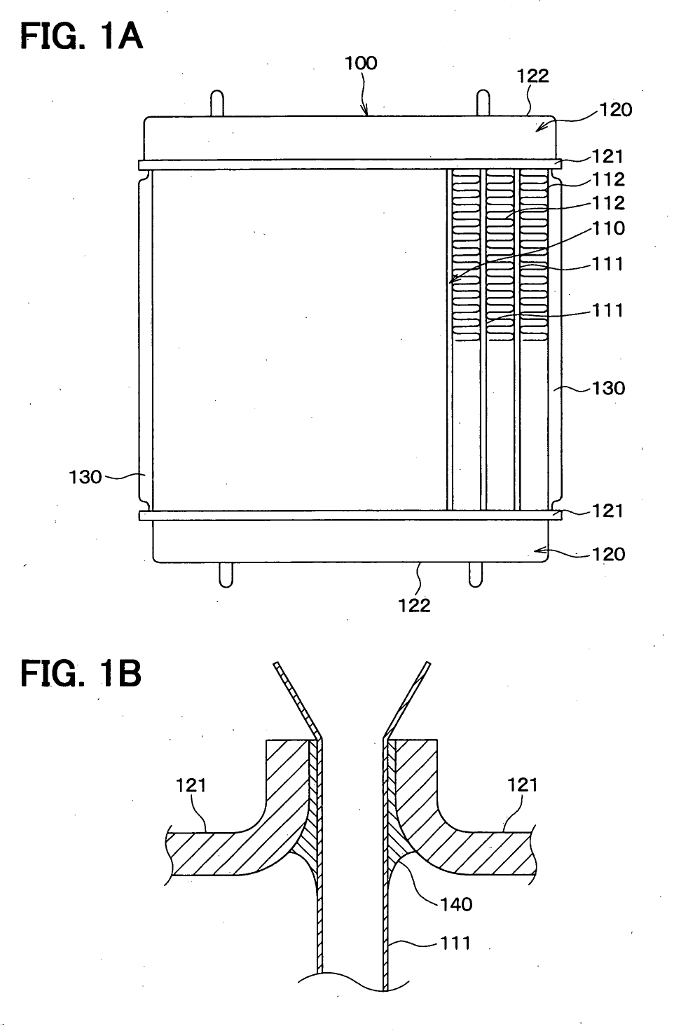

An exemplary embodiment of the present invention will now be described with reference to FIGS. 1A to 6.

Referring to FIG. 1A, a heat exchanger 100 has components made of copper or copper alloy. The heat exchanger 100 generally includes a core 110, header tanks 120 and side plates 130. The core 110 includes tubes 111 and fins 112. The tubes 111 are generally flat pipes and define passages therein through which an internal fluid flows. The tubes 111 are arranged parallel to each other, and the fins 112 are disposed between the tubes 111 for facilitating heat exchange between the internal fluid and an external fluid flowing around the tubes 111. The fins 112 have a corrugate shape, for example. The tubes 111 and the fins 112 are joined to each other by brazing.

The header tanks 120 are connected to ends of the tubes 111. The header tanks 120 extend in a direction perpendicular to a longitudinal direction of the tubes 111. The header tanks 120 are in communication with the passages defined in the tubes 111. The internal fluid is distributed into the tubes 111 from one of the header tanks 120. After passing through the tubes 111, the internal fluid is collected in the other of the header tanks 120.

Each of the header tanks 120 includes a metallic header plate 121 and a tank body 122. The tank body 122 is connected to the header plate 121 to define a tank inner space therebetween. The tubes 111 are brazed with the header plate 121 such that the passages of the tubes 111 are in communication with the tank inner space.

The side plates 130 are disposed at ends of the core 110 and extend substantially parallel to the tubes 111. The side plates 130 are provided to reinforce the core 110. Longitudinal ends of the side plates 130 are joined to the header tanks 120, that is, to the header plates 121. Also, the side plates 130 are brazed with the core 110, such as the fins 112 disposed on outermost layer of the core 110.

FIG. 1B shows a joining portion between one of the tubes 111 and the header plate 121. As shown in FIG. 1B, the tube 111 is inserted into a through hole formed on the header plate 121. In this condition, the tube 111 is joined to the header plate 121 with a joint formed from a brazing filler metal 140.

For example, the heat exchanger 100 can be employed as various heat exchangers, such as a radiator for performing heat exchange between an engine cooling water and air, thereby to cool the engine cooling water; an intercooler for cooling supercharged air of an internal combustion engine; an oil cooler for cooling lubricating oil of an apparatus such as an internal combustion engine; an EGR cooler for cooling exhaust gas in an exhaust gas recirculation (EGR) system of an internal combustion engine; and the like.

At a step conducted prior to a brazing step in a manufacturing process of the heat exchanger 100, a brazing filler metal paste is used. The brazing filler metal paste is applied to joining portions (brazing portions) of the components of the heat exchanger 100. After the brazing step, the components are in condition of being joined to one another with the joints formed from the brazing filler metal 140.

In the present embodiment, to ease handling of the brazing filler metal 140, the brazing filler metal 140 is exemplarily used in the form of paste by being kneaded with an organic binder and an organic solvent. The brazing filler metal 140 in the form of paste has a predetermined viscosity so that it can be easily applied to the joining portions, for example, using a spray, a dispenser, and the like, or by screen coating, roll coating and the like. The brazing filler metal paste can be applied to the components before the components are assembled. Alternatively, the brazing filler metal paste can be applied to the joining portions after the components are assembled.

For example, the brazing filler metal paste can be applied to an entirety of the joining portion. As another example, the brazing filler metal paste can be applied only to an upper location of the joining portion in anticipation of flowing by gravitation. In this case, the brazing filler metal paste can be applied to a portion away from the joining portion. The components of the heat exchanger 100 can be brazed by a general brazing method, such as brazing under an inert atmosphere of nitrogen and the like or brazing under a reduction atmosphere using hydrogen and the like.

As examples of the organic binder, (meth)acrylic acid polymer, (meth)acrylic acid ester polymer, copolymer of (meth)acrylic acid and (meth)acrylic acid ester, polystyrene, copolymer of styrene and (meth)acrylic acid ester, polybutene, polyisobutylene, glycerin, and the like are used. As examples of the organic solvent, 3-methoxybutyl acetate, ethylene glycol monobutyl ether acetate, diethylene glycol monobutyl ether acetate, propylene glycol monomethylether acetate, butylacetate, n-propyl acetate, propylene glycol diacetate, propylene glycol n-propyl ether, dipropylene glycol n-propyl ether, aromatic hydrocarbon, aliphatic hydrocarbon, and the like are used.

The brazing filler metal 140 is used in a condition where powder of a quaternary alloy including tin (Sn), nickel (Ni), phosphorous (P) and copper (Cu), and copper powder are mixed. The quaternary alloy consists of from 0.1 to 27.4 mass percent tin, from 0.8 to 5.1 mass percent nickel, from 2.2 to 10.9 mass percent phosphorous, and the balance including copper and any unavoidable impurity. For example, in the brazing filler metal 140, a mixing ratio of the copper powder is from 2 to 20 mass percent, and the balance is the quaternary alloy.

Since the copper powder is mixed with the quaternary alloy, which has the composition ratio similar to eutectic, the brazing filler metal 140 achieves a melting point and fluidity substantially equal to those of a eutectic brazing filler metal. Further, because a copper phase, which is a factor of improving strength, increases, joining strength improves. In addition, because the quaternary alloy has a melting point lower than that of copper, the copper powder can be carried by the quaternary alloy, which melts prior to the copper powder.

Therefore, even if portions to be joined are tilted, it is less likely that a copper-rich portion will remain at an upper location in the joining portions. Thus, the joint with uniform composition can be formed.

In a case where the composition ratio of the quaternary alloy is set to a hyper-eutectic, the fluidity is improved higher than that of a eutectic composition. In this case, however, voids are likely to be easily generated.

In the brazing filler metal 140 of the present embodiment, since the copper powder is mixed with the quaternary alloy, generation of the voids can be reduced.

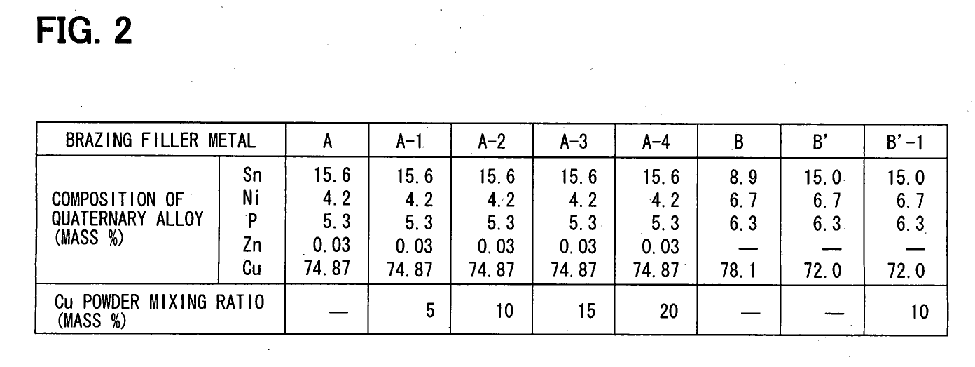

Referring to FIG. 2, brazing filler metals A-1, A-2, A-3, A-4 and B′-1 are specific examples of the brazing filler metal 140 of the present embodiment, and brazing filler metals A, B and B′ are comparative examples to the brazing filler metal of the present embodiment. Each of the brazing filler metals shown in FIG. 2 is in the form of powder made by gas atomizing and having passed through a sieve having 87 μm apertures. The copper powder contained in the brazing filler metals A-1, A-2, A-3, A-4 and B′-1 has an average particle diameter of 34 μm.

The brazing filler metal A is a brazing filler metal having a low melting point for joining copper or copper alloy. The brazing filler metal A contains only a quaternary alloy consisting of 15.6 mass percent tin, 4.2 mass percent nickel, 5.3 mass percent phosphorous, and 0.03 mass percent zinc, the balance being copper. The brazing filler metals A-1, A-2, A-3 and A-4 are respectively provided by mixing the copper powder with the brazing filler metal A.

Specifically, in the brazing filler metal A-1, a mixing ratio of the copper powder is 5 mass percent, and the balance is a quaternary alloy having the composition ratio same as that of the quaternary alloy of the brazing filler metal A. In the brazing filler metal A-2, a mixing ratio of the copper powder is 10 mass percent, and the balance is a quaternary alloy having the composition ratio same as that of the quaternary alloy of the brazing filler metal A. In the brazing filler metal A-3, a mixing ratio of the copper powder is 15 mass percent, and the balance is a quaternary alloy having the composition ratio same as that of the quaternary alloy of the brazing filler metal A. In the brazing filler metal A-4, a mixing ratio of the copper powder is 20 mass percent, and the balance is a quaternary alloy having the composition ratio same as that of the quaternary alloy of the brazing filler metal A.

In the brazing filler metal B, the ratio of tin is reduced and the ratio of copper is increased with respect to those of the brazing filler metal A so as to improve the joining strength while sacrificing the fluidity and the low-melting point. The brazing filler metal B contains only a quaternary alloy consisting of 8.9 mass percent tin, 6.7 mass percent nickel, 6.3 mass percent phosphorous, and the balance being copper.

In the brazing filler metal B′, the ratio of tin is increased to 15.0 mass percent and the ratio of copper is reduced in accordance with the increase in the tin, with respect to those of the brazing filler metal B.

The brazing filler metal B′-1 is provided by mixing the copper powder with the brazing filler metal B′. In the brazing filler metal B′-1, a mixing ratio of the copper powder is 10 mass percent, and the balance is a quaternary alloy having the composition ratio same as that of the quaternary alloy of the brazing filler metal B′.

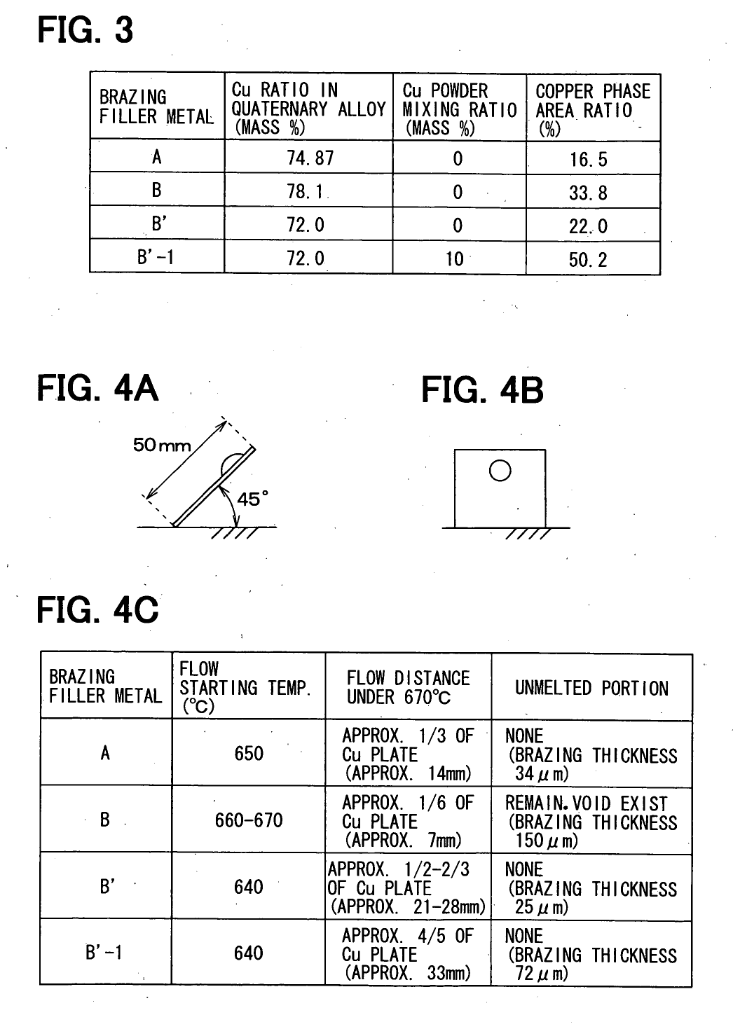

Next, a copper phase area ratio of the brazing filler metal 140 will be described. FIG. 3 shows the copper phase area ratio of the brazing filler metals A, B, B′ and B′-1. In the experiment of FIG. 3, powder of each of the brazing filler metals A, B, B′ and B′-1 is deposited on a copper plate using a mask having an aperture diameter of 6.5 mm and a thickness of 250 μm. The deposited brazing filler metals A, B, B′ and B′-1 are heated up to 650 degrees Celsius at an increase in temperature of 2 degrees Celsius per minute under a nitrogen atmosphere, held for thirty minutes, and then cooled. A cross-section of each of the brazing filler metals A, B, B′ and B′-1 after being solidified is observed through an optical microscope and the copper phase area ratio thereof is measured through an image analyzing apparatus.

As shown in FIG. 3, the brazing filler metal B′-1 in which the copper powder is mixed with the quaternary alloy has a copper phase area ratio much higher than those of the brazing filler metals A, B and B′. An increase in the copper phase area contributes to improvement of the strength (toughness). As such, it is appreciated that the strength can be increased by mixing the copper powder with the quaternary alloy in the brazing filler metal 140 of the present embodiment.

For example, the copper powder mixed in the brazing filler metal 140 has an average particle diameter of from 1 to 50 μm. If the particle diameter of the copper powder is large, cores of the particles of the copper powder are not sufficiently melted during the brazing. Particularly, if the particle diameter is greater than 50 μm, cores of most particles of the copper powder will not be melted, and hence the copper phase will not be educed. Therefore, the particle diameter of the copper powder is exemplarily equal to or less than 50 μm. If the particle diameter of the copper powder is smaller than 1 μm, an effect of surface oxidation is increased during the brazing, easily resulting in insufficient wetting. Therefore, the particle diameter of the copper powder is exemplarily equal to or greater than 1 μm.

Next, the melting point and the fluidity of the brazing filler metal 140 will be described. FIGS. 4A and 4B show a testing apparatus for testing the fluidity of the brazing filler metal 140. FIG. 4C shows test results of the fluidity of the brazing filler metals A, B, B′ and B′-1. In the experiment of the fluidity of the FIGS. 4A and 4B, the brazing filler metals A, B, B′ and B′-1 are used in the form of paste by being kneaded with a binder and an organic solvent. As the binder, polyisobutylene is used. Also, as the organic solvent, aliphatic hydrocarbon is used. The ratio of the brazing filler metal powder, the binder and the organic solvent is 89:1.32:9.68.

As shown in FIGS. 4A and 4B, the brazing filler metal in the form of paste is deposited on the copper plate that is tilted 45 degrees with respect to a horizontal plane. In this condition, the deposited brazing filler metal paste is heated under the atmosphere of 10 percent hydrogen and 90 percent nitrogen. Further, a distance of flow of the brazing filler metal paste when reached 670 degrees Celsius is measured.

As shown in FIG. 4C, a flow starting temperature of the brazing filler metal B′-1, that is, the temperature that the brazing filler metal B′-1 in which the copper powder is mixed begins to flow, is lower than that of the brazing filler metal B, and is substantially equal to that of the brazing filler metal A, which has the low melting point. That is, it is appreciated that the brazing filler metal 140 of the present embodiment has a sufficiently low melting point.

Further, the distance of flow of the brazing filler metal B′-1 is greater than those of the other brazing filler metals A, B and B′. This indicates that the brazing filler metal B′-1 has sufficient fluidity. In addition, the brazing filler metal B′-1 does not have the unmelted portion in the deposited portion. Moreover, a brazing thickness of the brazing filler metal B′-1 is less than that of the brazing filler metal B.

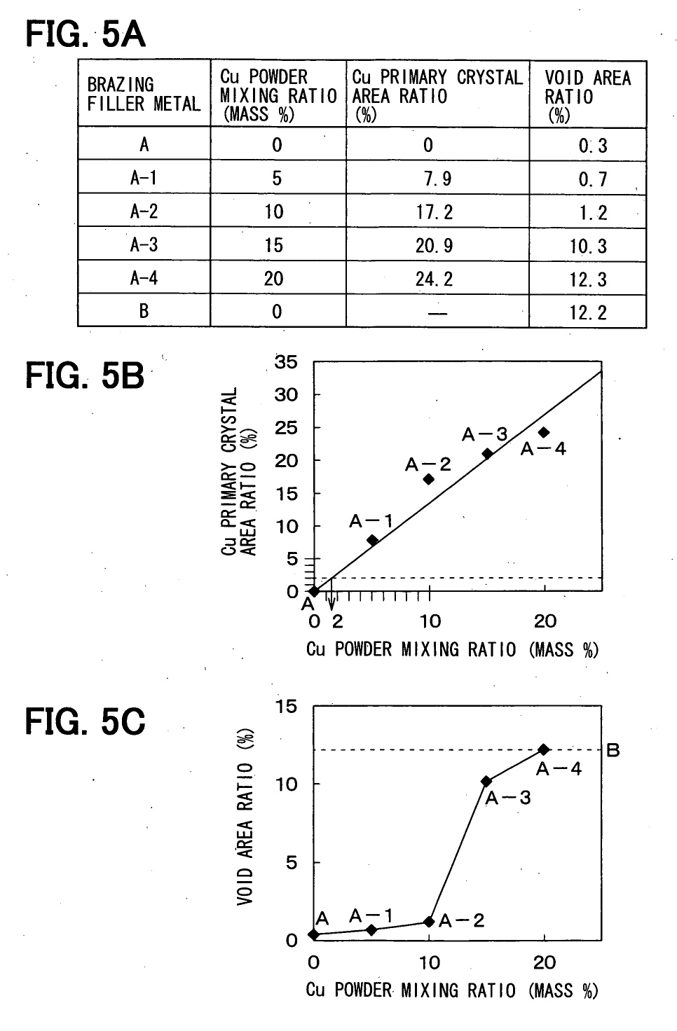

Next, a relationship between the strength of the brazing filler metal 140 and the mixing ratio of the copper powder will be described. FIG. 5A shows a primary crystal area ratio of copper and a void area ratio of the brazing filler metals A, A-1, A-2, A-3, A-4 and B. FIG. 5B shows a relationship between the mixing ratio of the copper powder and the primary crystal area ratio of copper. FIG. 5C shows a relationship between the mixing ratio of the copper powder and the void area ratio.

In the experiment of FIGS. 5A to 5C, powder of each of the brazing filler metals A, A-1, A-2, A-3, A-4 and B is deposited on an aluminum plate using a mask having an aperture diameter of 6.5 mm and a thickness of 250 μm. The deposited brazing filler metals A, A-1, A-2, A-3, A-4 and B are heated up to 650 degrees Celsius at an increase in temperature of 2 degrees Celsius per minute under the nitrogen atmosphere, held for thirty minutes, and then cooled. The cross-section of each of the solidified brazing filler metals A, A-1, A-2, A-3, A-4 and B is observed through an optical microscope, and the void area ratio and the primary crystal area ratio of copper are measured through an image analyzing apparatus.

As shown in FIGS. 5A and 5B, in the brazing filler metals A-1, A-2, A-3 and A-4, which are respectively provided by mixing the copper powder with the brazing filler metal A, the primary crystal area ratio of copper increases with an increase in the mixing ratio of the copper powder. The increase in the primary crystal area ratio of the copper indicates the increase in the strength (toughness). On the other hand, in a case where the primary crystal area ratio of copper is equal to or less than 2 percent, it is difficult to expect sufficient strength. Therefore, the mixing ratio of the copper powder in the brazing filler metal 140 is exemplarily set to equal to or more than 2 mass percent such that the primary crystal area ratio exceeds 2 percent.

As shown in FIGS. 5A and 5C, in the brazing filler metals A-1, A-2, A-3 and A-4, the void area ratio increases with the increase in the mixing ratio of the copper powder. This is because the fluidity of the brazing filler metal deteriorates with the increase in the copper powder and hence bubbles therein are trapped. The brazing filler metal A-4 in which the mixing ratio of the copper powder is 20 mass percent has the void area ratio substantially equal to that of the brazing filler metal B. Therefore, the mixing ratio of the copper powder in the brazing filler metal 140 is exemplarily equal to or less than 20 mass percent.

Next, the ratio of tin in the quaternary alloy of the brazing filler metal 140 will be described. The ratio of tin in the quaternary alloy is, for example, from 10 to 20 mass percent. Preferably, the ratio of tin in the quaternary alloy is from 12 to 18 mass percent. Hereinafter, the reason of the above ratios of tin will be described.

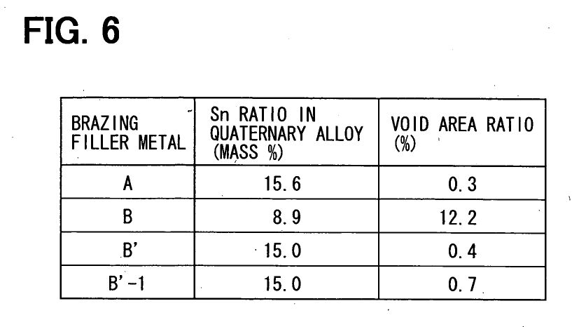

FIG. 6 shows the void area ratio of the brazing filler metals A, B, B′ and B′-1. In the experiment of FIG. 6, the void area ratio is measured in the similar method of the experiment of FIGS. 5A to 5C. As shown in FIG. 6, the brazing filler metals A, B′ and B′-1 in which the ratio of tin in the quaternary alloy is equal to or more than 15 mass percent have a void area ratio much smaller than that of the brazing filler metal B in which the ratio of tin in the quaternary alloy is 8.9 mass percent.

That is, in a case where the ratio of tin in the quaternary alloy is approximately 15 mass percent, the sufficient fluidity is provided, and thus the void area ratio can be reduced. Further, the ratio of tin affects the melting point of the quaternary alloy. As such, the ratio of tin is determined so as to satisfy both the preferable void area ratio and the preferable melting point of the quaternary alloy. It is found that the ratio of tin, which contributes to the decrease in the void area ratio and the decrease in the melting point of the quaternary alloy, is 15±5 mass percent, that is, in a range between equal to or greater than 10 mass percent and equal to or less than 20 mass percent. Furthermore, to realize a practical void area ratio and a practical melting point of the quaternary alloy, the ratio of tin is exemplarily 15±3 mass percent, that is, in a range between equal to or less than 12 mass percent and equal to or less than 18 mass percent.

As discussed above, by employing the brazing filler metal 140 of the present embodiment, a uniform and high quality copper brazing joint having the sufficient joining strength can be provided under the low brazing temperature (e.g., from 600 to 650 degrees Celsius). Since the brazing filler metal 140 of the present embodiment has the sufficient fluidity, satisfactory brazing fillets can be formed. Therefore, the usage and costs can be reduced.

### Other Embodiments

In the above, the brazing filler metal 140 is exemplarily employed to join members of the heat exchanger 100. However, the use of the brazing filler metal 140 is not limited to the heat exchanger. For example, the brazing filler metal 140 can be employed to join any members, such as pipes made of copper or copper alloy. Further, the brazing filler metal 140 can be employed to join members for large equipment or members that are used under a high temperature condition and/or a highly corrosive condition.

In the above, the brazing filler metal 140 is used in the form of paste by being kneaded with the organic binder and the organic solvent. However, the form of the brazing filler metal 140 when in use is not limited to the paste. For example, the brazing filler metal 140 can be used in the form of powder.

Additional advantages and modifications will readily occur to those skilled in the art. The invention in its broader term is therefore not limited to the specific details, representative apparatus, and illustrative examples shown and described.

What is claimed is:

1. A brazing filler metal for joining members made of one of copper and copper alloy, the brazing filler metal comprising:
quaternary alloy powder consisting of from 0.1 to 27.4 mass percent tin, from 0.8 to 5.1 mass percent nickel, from 2.2 to 10.9 mass percent phosphorous and a balance including copper and any unavoidable impurity; and
copper powder.

2. The brazing filler metal according to claim 1, wherein
a mixing ratio of the copper powder is from 2 to 20 mass percent.

3. The brazing filler metal according to claim 1, wherein
the copper powder has a particle diameter of from 1 to 50 μm.

4. The brazing filler metal according to claim 1, wherein
a ratio of the tin in the quaternary alloy powder is from 10 to 20 mass percent.

5. The brazing filler metal according to claim 4, wherein
the ratio of the tin in the quaternary alloy is from 12 to 18 mass percent.

6. A brazing filler metal paste for joining members made of one of copper and copper alloy, the brazing filler metal paste comprising:
a brazing filler metal;
an organic binder; and
an organic solvent, wherein
the brazing filler metal comprises:
quaternary alloy powder consisting of from 0.1 to 27.4 mass percent tin, from 0.8 to 5.1 mass percent nickel, from 2.2 to 10.9 mass percent phosphorous and a balance including copper and any unavoidable impurity; and
copper powder.

7. A heat exchanger comprising:
a first member made of one of copper and copper alloy;
a second member made of one of copper and copper alloy; and
a joint joining the first member and the second member, wherein the joint is formed from a brazing filler metal, the brazing filler metal comprising:
quaternary alloy powder consisting of from 0.1 to 27.4 mass percent tin, from 0.8 to 5.1 mass percent nickel, from 2.2 to 10.9 mass percent phosphorous and a balance including copper and any unavoidable impurity; and
copper powder.

8. A heat exchanger comprising:
a first member made of one of copper and copper alloy;
a second member made of one of copper and copper alloy; and
a joint joining the first member and the second member, wherein the joint is formed from a brazing filler metal paste comprising a brazing filler metal, an organic binder and an organic solvent, the brazing filler metal comprising:
quaternary alloy powder consisting of from 0.1 to 27.4 mass percent tin, from 0.8 to 5.1 mass percent nickel, from 2.2 to 10.9 mass percent phosphorous and a balance including copper and any unavoidable impurity; and
copper powder.
